(19) United States
(12) Patent Application Publication
(10) Pub. No.: US 2008/0027727 A1
(43) Pub. Date: Jan. 31, 2008

(54) SPEECH SYNTHESIS APPARATUS AND METHOD

(75) Inventors: Masahiro MORITA, Kanagawa-ken (JP); Takehiko Kagoshima, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/781,424

(22) Filed: Jul. 23, 2007

(30) Foreign Application Priority Data
Jul. 31, 2006 (JP) 2006-208421

(51) Int. Cl. G10L 13/06

(52) U.S. Cl. 704/267; 704/E13.009

(57) ABSTRACT

A speech unit corpus stores a group of speech units. A selection unit divides a phoneme sequence of target speech into a plurality of segments, and selects a combination of speech units for each segment from the speech unit corpus. An estimation unit estimates a distortion between the target speech and synthesized speech generated by fusing each speech unit of the combination for each segment. The selection unit recursively selects the combination of speech units for each segment based on the distortion. A fusion unit generates a new speech unit for each segment by fusing each speech unit of the combination selected for each segment. A concatenation unit generates synthesized speech by concatenating the new speech unit for each segment.

### CROSS-REFERENCE TO RELATED APPLICATIONS

This application is based upon and claims the benefit of priority from prior Japanese Patent Application No. 2006-208421, filed on Jul. 31, 2006; the entire contents of which are incorporated herein by reference.

### FIELD OF THE INVENTION

The present invention relates to a speech synthesis apparatus and a method for synthesizing speech by fusing a plurality of speech units for each segment.

### BACKGROUND OF THE INVENTION

Artificial generation of a speech signal from an arbitrary sentence is called text speech synthesis. In general, a language processing unit, a prosody processing unit, and a speech synthesis unit perform text speech synthesis. The language processing unit morphologically and semantically analyzes an input text. The prosody processing unit processes accent and intonation of the text based on the analysis result, and outputs a phoneme sequence/prosodic information (fundamental frequency, phoneme segmental duration, power). The speech synthesis unit synthesizes a speech signal based on the phoneme sequence/prosodic information. In the speech synthesis unit, a method for generating a synthesized speech from arbitrary phoneme sequence (generated by the prosody processing unit) in arbitrary prosody is used.

As such speech synthesis method, by setting input phoneme sequence/prosodic information as a target, the unit selection method for synthesizing a plurality of speech units by selecting from a large number of speech units (previously stored) is known (JP-A(Kokai) No. 2001-282278). In this method, distortion degree (cost) of synthesized speech is defined as a cost function, and the speech unit having the lowest cost is selected. For example, modification distortion and concatenation distortion respectively caused by modifying/concatenating speech units are evaluated using the cost. A speech unit sequence used for speech synthesis is selected based on the cost, and a synthesized speech is generated from the speech unit sequence.

Briefly, in this speech synthesis method, adaptive speech unit sequence is selected from the large number of speech units by estimating the distortion degree of a synthesized speech. As a result, the synthesized speech suppressing fall of speech quality (caused by modifying/concatenating units) is generated.

However, in the unit selection-speech synthesis method, speech quality of synthesized sound partially falls. Some reasons are as follows. First, even if a large number of speech units are previously stored, adaptive speech unit for various phoneme/prosodic environment does not always exist. Second, a suitable unit sequence is not always selected because the cost function cannot perfectly represent distortion degree of synthesized speech actually felt by a user. Third, defective speech units cannot be previously excluded because a large number of speech units exist. Fourth, the defective speech units are unexpectedly mixed into a speech unit sequence selected because design of the cost function to exclude the defective speech unit is difficult.

Accordingly, another speech synthesis method is proposed (JP-A (Kokai) No. 2005-164749). In this method, a plurality of speech units is selected for each synthesis unit (each segment) instead of selection of one speech unit. A new speech unit is generated by fusing the plurality of speech units, and speech is synthesized using the new speech units. Hereinafter, this method is called a plural unit selection and fusion method.

In the plural unit selection and fusion method, a plurality of speech units are fused for each synthesis unit (each segment). Even if an adequate speech unit matched with a target (phoneme/prosodic environment) does not exist, or even if a defective speech unit is selected instead of an adaptive speech unit, a new speech unit having high quality is newly generated. Furthermore, by synthesizing speech using the new speech units, the above-mentioned problem of the unit selection method is improved, and speech synthesis with high quality is stably realized.

Concretely, in case of selecting a plurality of speech units for each synthesis unit (each segment), the following steps are executed.
(1) One speech unit is selected for each synthesis unit (each segment) so that a total cost of a speech unit sequence for all synthesis units (all segments) is the minimum. (Hereinafter, the speech unit sequence is called an optimum unit sequence)
(2) One speech unit in the optimum unit sequence is replaced by another speech unit, and the total cost of the optimum unit sequence is calculated again. A plurality of speech units in lower order of cost is selected for each synthesis unit (each segment) in the optimum unit sequence.

However, in this method, effect that a plurality of speech units selected is fused is not clearly considered. Furthermore, in this method, speech units each having phoneme/prosodic environment matched with a target (phoneme/prosodic environment) are respectively selected. Accordingly, total phoneme/prosodic environment of the speech units does not always match with the target (phoneme/prosodic environment). As a result, a synthesized speech by fusing the speech units of each segment often shifts from a target speech, and effect by fusion cannot sufficiently obtained.

Furthermore, a number of speech units to be fused is different for each segment. By adaptively controlling the number of speech units for each segment, speech quality will improve. However, this specific method is not proposed.

### SUMMARY OF THE INVENTION

The present invention is directed to a speech synthesis apparatus and a method for suitably selecting a plurality of speech units to be fused for each segment.

According to an aspect of the present invention, there is provided an apparatus for synthesizing speech, comprising: a speech unit corpus configured to store a group of speech units; a selection unit configured to divide a phoneme sequence of target speech into a plurality of segments, and to select a combination of speech units for each segment from the speech unit corpus; an estimation unit configured to estimate a distortion between the target speech and synthesized speech generated by fusing each speech unit of the combination for each segment; wherein the selection unit recursively selects the combination of speech units for each segment based on the distortion, a fusion unit configured to generate a new speech unit for each segment by fusing each speech unit of the combination selected for each segment; and a concatenation unit configured to generate synthesized speech by concatenating the new speech unit for each segment.

According to another aspect of the present invention, there is also provided a method for synthesizing speech, comprising: storing a group of speech units; dividing a phoneme sequence of target speech into a plurality of segments; selecting a combination of speech units for each segment from the group of speech units; estimating a distortion between the target speech and synthesized speech generated by fusing each speech unit of the combination for each segment; recursively selecting the combination of speech units for each segment based on the distortion; generating a new speech unit for each segment by fusing each speech unit of the combination selected for each segment; and generating synthesized speech by concatenating the new speech unit for each segment.

According to still another aspect of the present invention, there is also provided a computer program product, comprising: a computer readable program code embodied in said product for causing a computer to synthesize speech, said computer readable program code comprising: a first program code to store a group of speech units; a second program code to divide a phoneme sequence of target speech into a plurality of segments; a third program code to select a combination of speech units for each segment from the group of speech units; a fourth program code to estimate a distortion between the target speech and synthesized speech generated by fusing each speech unit of the combination for each segment; a fifth program code to recursively select the combination of speech units for each segment based on the distortion; a sixth program code to generate a new speech unit for each segment by fusing each speech unit of the combination selected for each segment; and a seventh program code to generate synthesized speech by concatenating the new speech unit for each segment.

### BRIEF DESCRIPTION OF THE DRAWINGS

FIG. 1 is a block diagram of a speech synthesis apparatus according to a first embodiment.

FIG. 2 is a block diagram of a speech synthesis unit 4 in FIG. 1.

FIG. 3 is one example of speech waveforms in a speech unit corpus 42 in FIG. 2.

FIG. 4 is one example of unit environment in a speech unit environment corpus 43 in FIG. 2.

FIG. 5 is a block diagram of a fused unit distortion estimation unit 45 in FIG. 2.

FIG. 6 is a flow chart of selection processing of speech unit according to the first embodiment.

FIG. 7 is one example of speech unit candidates of each segment according to the first embodiment.

FIG. 8 is one example of an optimum unit sequence selected from the speech unit candidates in FIG. 7.

FIG. 9 is one example of unit combination candidates generated from the optimum unit sequence in FIG. 8.

FIG. 10 is one example of an optimum unit combination sequence selected from the unit combination candidates in FIG. 10.

FIG. 11 is one example of the optimum unit combination sequence in case of “M=3”.

FIG. 12 is a flow chart of generation processing of new speech waveform by fusing speech waveforms according to the first embodiment.

FIG. 13 is one example of generation processing of new speech unit 63 by fusing unit combination candidates 60 having selected three speech units.

FIG. 14 is a schematic diagram of processing of a unit editing-concatenation unit 47 in FIG. 2.

FIG. 15 is a schematic diagram of concept of unit selection in case of not estimating distortion of fused speech units.

FIG. 16 is a schematic diagram of concept of unit selection in case of estimating distortion of fused speech units.

FIG. 17 is a block diagram of a fused unit distortion estimation unit 49 according to the second embodiment.

FIG. 18 is a flow chart of processing of the fused unit distortion estimation unit 49 according to the second embodiment.

### DETAILED DESCRIPTION OF THE EMBODIMENTS

Hereinafter, various embodiments of the present invention will be explained by referring to the drawings. The present invention is not limited to the following embodiments.

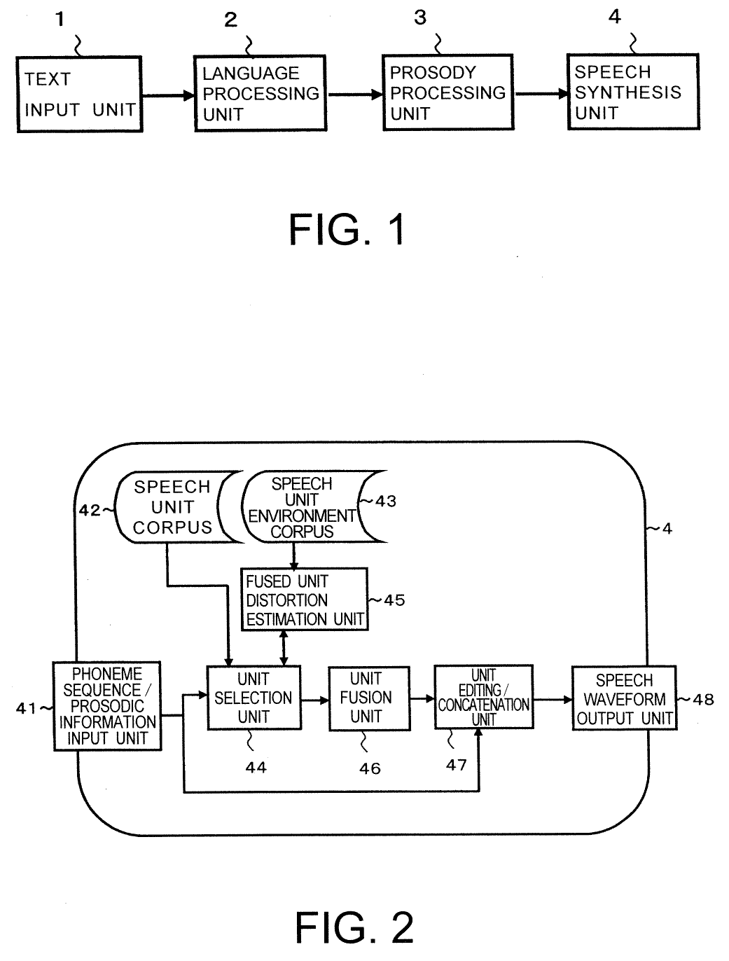

FIG. 1 is a block diagram of a speech synthesis apparatus according to a first embodiment. The speech synthesis apparatus comprises a text input unit 1, a language processing unit 2, a prosody processing unit 3, and a speech synthesis unit 4. The text input unit 1 inputs text. The language processing unit 2 morphologically and syntactically analyzes the text. The prosody processing unit 3 processes accent and intonation from the language analysis result, and generates a phoneme sequence/prosodic information. The speech synthesis unit 4 generates speech waveforms based on the phoneme sequence/prosodic information, and generates a synthesized speech using the speech waveforms.

In the first embodiment, specific features relate to the speech synthesis unit 4. Accordingly, component and operation of the speech synthesis unit 4 are mainly explained. FIG. 2 is a block diagram of the speech synthesis unit 4.

As shown in FIG. 2, the speech synthesis unit 4 includes a phoneme sequence/prosodic information input unit 41, a speech unit corpus 42, a speech unit environment corpus 43, a unit selection unit 44, a fused unit distortion estimation unit 45, a unit fusion unit 46, a unit editing/concatenation unit 47, and a speech waveform output unit 48. The phoneme sequence/prosodic information input unit 41 inputs a phoneme sequence/prosodic information from the prosody processing unit 3. The speech unit corpus (memory) 42 stores a large number of speech units. The speech unit environment corpus (memory) 43 stores a phoneme/prosodic environment corresponding to each speech unit stored in the speech unit corpus 42. The unit selection unit 44 selects a plurality of speech units from the speech unit corpus 42. The fused unit distortion estimation unit 45 estimates distortion caused by fusing the plurality of speech units. The unit fusion unit 46 generates new speech unit by fusing the plurality of speech units selected for each segment. The editing/concatenation unit 47 generates a waveform of synthesized speech by modifying (editing)/concatenating the new speech units of all segments. The speech waveform output unit 48 outputs the speech waveform generated by the unit editing/concatenation unit 47.

Next, detailed processing of each unit is explained by referring to FIGS. 2-5. First, the phoneme sequence/prosodic information input unit 41 outputs the phoneme sequence/prosodic information (input from the prosody processing unit 3) to the unit selection unit 44. For example, the phoneme sequence is a sequence of phoneme sign, and the prosodic information is a fundamental frequency, a phoneme segmental duration, and a power. Hereinafter, the phoneme sequence/prosodic information input to the phoneme sequence/prosodic information input unit 41 are respectively called input phoneme sequence/input prosodic information.

The speech unit corpus 42 stores a large number of speech units for a synthesis unit to generate synthesized speech. The synthesis unit is a combination of a phoneme or a divided phoneme, for example, a half-phoneme, a phone (C,V), a diphone (CV,VC,VV), a triphone (CVC,VCV), a syllable (CV,V) (V: vowel, C: consonant). These may be variable length as mixture. The speech unit is a parameter sequence representing waveform or feature of speech signal corresponding to synthesis unit.

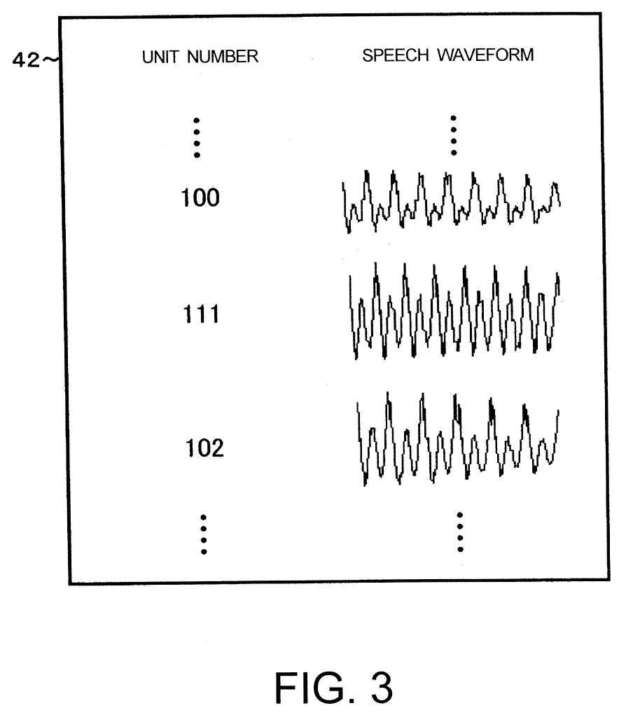

FIG. 3 shows one example of speech units stored in the speech unit corpus 42. As shown in FIG. 3, a speech unit (waveform of speech signal of each phoneme) and a unit number identifying the speech unit are correspondingly stored. In order to obtain the speech unit, each phoneme in speech data (previously recorded) is labeled and a speech waveform of each labeled phoneme is extracted from the speech data.

The speech unit environment corpus 43 stores phoneme/prosodic environment corresponding to each speech unit stored in the speech unit corpus 42. The phoneme/prosodic environment is combination of environmental factor of each speech unit. The factor is, for example, a phoneme name, a previous phoneme, a following phoneme, a second following phoneme, a fundamental frequency, a phoneme segmental duration, a power, a stress, a position from accent core, a time from breath point, an utterance speed, and a feeling. Furthermore, acoustic feature to select speech unit such as cepstrum coefficient at start point and end point is stored. The phoneme/prosodic environment and the acoustic feature stored in the speech unit environment corpus 43 are called a unit environment.

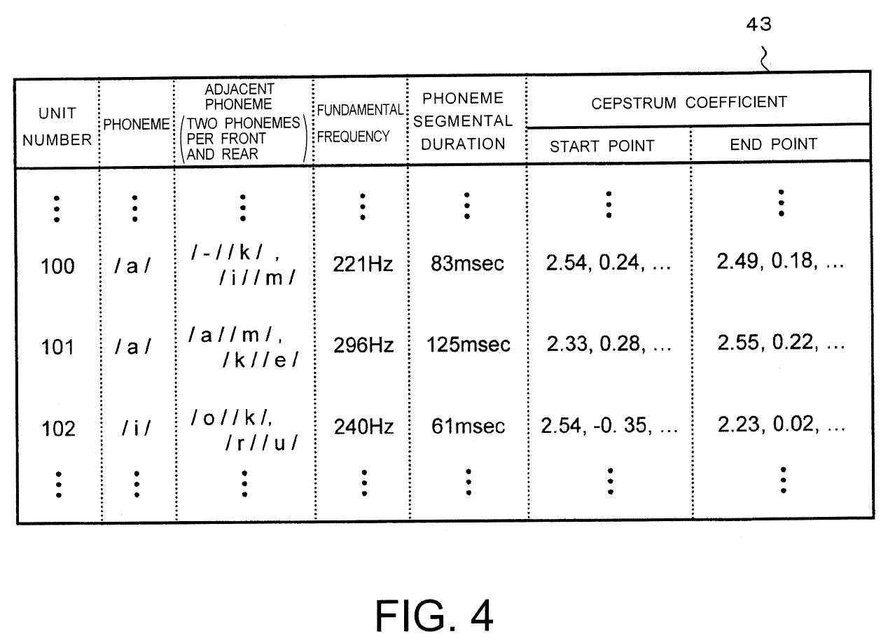

FIG. 4 is one example of the unit environment stored in the speech unit environment corpus 43. As shown in FIG. 4, the unit environment corresponding to a unit number of each speech unit in the speech unit corpus 42 is stored. As the phoneme/prosodic environment, a phoneme name, adjacent phonemes (two phonemes per front and rear of the phoneme), a fundamental frequency, a phoneme segmental duration, and cepstrum coefficients at start point and end point of the speech unit.

In order to obtain the unit environment, speech data from which the speech unit is extracted is analyzed, and the unit environment is extracted from the analysis result. In FIG. 4, a synthesis unit of the speech unit is a phoneme. However, a half-phoneme, a diphone, a triphon, a syllable, or combination of these factors may be stored.

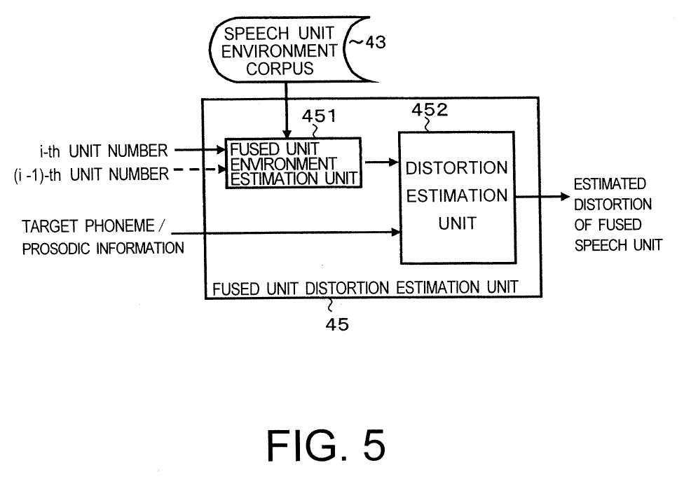

FIG. 5 is a block diagram of the fused unit distortion estimation unit 45. The fused unit distortion estimation unit 45 includes a fused unit environment estimation unit 451 and a distortion estimation unit 452. The fused unit environment estimation unit 451 estimates a unit environment of a new speech unit generated by fusing a plurality of speech units input from the unit selection unit 44. The distortion estimation unit 452 estimates a distortion of the plurality of speech units fused based on the unit environment (estimated by the fused unit environment estimation unit 451) and target phoneme/prosodic information (input by the unit selection unit 44).

The fused unit environment estimation unit 451 inputs a unit number of a speech unit selected for i-th segment to estimate distortion and a unit number of a speech unit selected for (i-1)-th segment adjacent to the i-th segment. By referring to the speech unit environment corpus 43 based on the unit number, the fused unit environment estimation unit 451 estimates a unit environment of fused speech unit candidates of the i-th segment and a unit environment of fused speech units candidates of the (i-1)-th segment. The unit environments are input to the distortion estimation unit 452.

Next, operation of the speech synthesis unit 4 is explained by referring to FIGS. 2-14. A phoneme sequence input to the unit selection unit 44 (from the phoneme sequence/prosodic information input unit 41 in FIG. 2) is divided into a plurality of synthesis units. Hereinafter, a synthesis unit is regarded as a segment. The unit selection unit 44 selects a plurality of combination candidates of speech units to be fused for each segment by referring to the speech unit corpus 42. The plurality of combination candidates of speech units of the i-th segment (Hereinafter, it is called i-th speech unit combination candidates) and a target phoneme/prosodic information are output to the fused unit distortion estimation unit 45. As to the target phoneme/prosodic information, input phoneme sequence/input prosodic information is used.

As shown in FIG. 5, i-th speech unit combination candidates and (i-1)-th speech unit combination candidates are input to the fused unit environment estimation unit 451. By referring to the speech unit environment corpus 43, the fused unit environment estimation unit 451 estimates a unit environment of i-th speech unit fused from the i-th speech unit combination candidates and a unit environment of (i-1)-th speech unit fused from (i-1)-th speech unit combination candidates (Hereinafter, they are respectively called i-th estimated unit environment and (i-1)-th estimated unit environment). These estimated unit environments are output to the distortion estimation unit 452.

The distortion estimation unit 452 inputs the i-th estimated unit environment and the (i-1)-th estimated unit environment from the fused unit environment estimation unit 452, and inputs a target phoneme/prosodic environment information from the unit selection unit 44. Based on these information, the distortion estimation unit 452 estimates a distortion between a target speech and a synthesized speech fused from the speech unit combination candidates of each segment (Hereinafter, it is called an estimated distortion of fused speech units). The estimated distortion is output to the unit selection unit 44. Based on the estimated distortion of fused speech units by the speech unit combination candidates of each segment, the unit selection unit 44 recursively selects speech unit combination candidates to minimize the distortion of each segment, and outputs the speech unit combination candidates to the unit fusion unit 46.

The unit fusion unit 46 generates a new speech unit for each segment by fusing the speech unit combination candidates of each segment (input from the unit selection unit 44), and outputs the new speech unit for each segment to the unit editing/concatenation unit 47. The unit editing/concatenation unit 47 inputs the new speech unit (from the unit fusion unit 46) and a target prosodic information (from the phoneme sequence/prosodic information input unit 41). Based on the target prosodic information, the unit editing/concatenation unit 47 generates a speech waveform by modifying (editing) and concatenating the new speech unit of each segment. This speech waveform is output from the speech waveform output unit 48.

Next, operation of the fused unit distortion estimation unit 45 is explained by referring to FIG. 5. Based on the i-th estimated unit environment, the (i-1)-th estimated unit environment (each input from the fused unit environment estimation unit 451), and the target phoneme/prosodic information (input from the unit selection unit 44), the distortion estimation unit 452 calculates an estimated distortion of fused speech units of i-th speech unit combination candidates. In this case, as a degree of distortion, “cost” is used in the same way as the unit selection method or the plural unit selection and fusion method. Cost is defined by a cost function. Accordingly, the cost and the cost function are explained in detail.

The cost is classified into two costs (a target cost and a concatenation cost). The target cost represents a distortion degree between a target speech and a synthesized speech generated from a speech unit of cost calculation object. Hereinafter, the speech unit is called an object unit. The object unit is used in the target phoneme/prosodic environment. The concatenation cost represents a distortion degree between the target speech and a synthesized speech generated from the object unit concatenated with an adjacent speech unit.

The target cost and the concatenation cost respectively include a sub cost of each distortion factor. A sub cost function Cₙ (uᵢ, uᵢ₋₁, tᵢ) (n=1, . . . , N, N: number of sub costs) is defined for each sub cost.

In the sub cost function, ti represents a phoneme/prosodic environment of i-th segment on condition of the target phoneme/prosodic environment t=(tᵢ, . . . , t_{I}) (I: number of segments), and uᵢ represents a speech unit of i-th segment.

The sub cost of the target cost includes a fundamental frequency cost, a phoneme segmental duration cost, and a phoneme environment cost. The fundamental frequency cost represents a difference between a target fundamental frequency and a fundamental frequency of the speech unit. The phoneme segmental duration cost represents a difference between a target phoneme segmental duration and a phoneme segmental duration of the speech unit. The phoneme environment cost represents a distortion between a target phoneme environment and a phoneme environment to which the speech unit belongs.

Concrete calculation method of each cost is explained. The fundamental frequency cost is calculated as follows.

C₁(u_{i,}uᵢ₋₁,tᵢ)={ log(f(vᵢ))−log(f(tᵢ))}² (1)

vᵢ: unit environment of speech unit uᵢ

f: function to extract average fundamental frequency from unit environment vᵢ

The phoneme segmental duration cost is calculated as follows.

C₂(u_{i,}uᵢ₋₁,tᵢ)={g(vᵢ)−g(tᵢ)}² (2)

g: function to extract phoneme segmental duration from unit environment vᵢ

The phoneme environment cost is calculated as follows.

$${C}_{3} ( {u}_{i} , {u}_{i - 1} , {t}_{i} ) = {\sum }_{j = - 2}^{2} {r}_{j} \cdot d ( p ( {v}_{i} , j ) , p ( {t}_{i} , j ) ) \qquad ( 3 )$$

j: relative position of a phoneme for the object phoneme

p: function to extract phoneme environment of the phoneme at the relative position j from unit environment vᵢ

d: function to calculate a distance (feature difference) between two phonemes

rⱼ: weight of the distance for the relative position j

A value of “d” is within “0”˜“1”. The value of d is “1” for the same two phonemes, and “0” for two phonemes if each feature is perfectly different.

On the other hand, a sub cost of the concatenation cost includes a spectral concatenation cost representing difference of spectral at a speech unit boundary. The spectral concatenation unit is calculated as follows.

C₄(uᵢ,uᵢ₋₁,tᵢ)=∥hₚᵣₑ(uᵢ)−hₚₒₛₜ(uᵢ₋₁)∥ (4)

∥: norm

hₚᵣₑ: function to extract cepstrum coefficient (vector) of concatetion boundary in front of speech unit uᵢ

hₚₒₛₜ: function to extract cepstrum coefficient (vector) of concatetion boundary in rear of speech unit uᵢ

A weighted sum of these sub cost functions is defined as a synthesis unit cost function as follows.

$$C ( {u}_{i} , {u}_{i - 1} , {t}_{i} ) = {\sum }_{n = 1}^{N} {w}_{n} \cdot {C}_{n} ( {u}_{i} , {u}_{i - 1} , {t}_{i} ) \qquad ( 5 )$$

wₙ: weight between sub costs

The above equation (5) represents calculation of synthesis unit cost as a cost which some speech unit is used for some segment.

As to a plurality of segments divided from an input phoneme sequence by a synthesis unit, the distortion estimation unit 452 calculates the synthesis unit cost by equation (5). The unit selection unit 44 calculates a total cost by summing the synthesis unit cost of all segments as follows.

$$TC = {\sum }_{i = 1}^{I} {( C ( {u}_{i} , {u}_{i - 1} , {t}_{i} ) )}^{p} \qquad ( 6 )$$

P: constant

In order to simplify the explanation, assume that “P=1”. Briefly, the total cost represents a sum of each synthesis unit cost. In other words, the total cost represents a distortion between a target speech and a synthesized speech generated from a speech unit sequence selected for input phoneme sequence. By selecting the speech unit sequence to minimize the total cost, synthesized speech having little distortion (compared with the target speech) can be generated.

In the above equation (6), “p” may be any value except for “1”. For example, if “p” is larger than “1”, a speech unit sequence locally having large synthesis unit cost is emphasized. In other words, a speech unit locally having large synthesis unit cost is difficult to be selected.

Next, operation of the fused unit distortion estimation unit 45 is explained using the cost function. First, the fused unit environment estimation unit 451 inputs unit numbers of speech unit combination candidates of i-th segment and (i-1)-th segment from the unit selection unit 44. In this case, one unit number or a plurality of unit numbers as the speech unit combination candidates may be input. Furthermore, if the target cost is taken into consideration without the concatenation cost, a unit number of speech unit combination candidates of (i-1)-th segment need not be input.

By referring to the speech unit environment corpus 43, the fused unit environment estimation unit 451 respectively estimates a unit environment of new speech unit fused from speech unit combination candidates of i-th segment and (i-1)-th segment, and outputs the estimation result to the distortion estimation unit 452. Concretely, a unit environment of the input unit number is extracted from the speech unit environment corpus 43, and output as i-th unit environment and (i-1)-th unit environment to the distortion estimation unit 452.

In the present embodiment, in case of fusing a unit environment of each speech unit extracted from the speech unit environment corpus 43, the fused unit environment estimation unit 451 outputs an average of the unit environment as i-th estimated unit environment and (i-1) -th estimated unit environment.

Concretely, an average of values of each speech unit of the speech unit combination candidates is calculated for each factor of the unit environment. For example, in case that a fundamental frequency of each speech unit is 200 Hz, 250 Hz, and 180 Hz, 210 Hz, the average of these three values, is output as a fundamental frequency of fused speech unit. In the same way, an average is calculated for factors having continuous values such as a phoneme segmental duration and a cepstrum coefficient.

As to a discrete symbol such as adjacent phoneme, an average cannot be simply calculated. In adjacent phonemes for a speech unit, a representative value can be obtained by selecting one adjacent phoneme most appeared or having the strongest influence for the speech unit. However, as to adjacent phonemes for a plurality of speech units, instead of the representative value, combination of the adjacent phonemes for each speech unit is used as adjacent phoneme of new speech unit fused from the plurality of speech units.

Next, the distortion estimation unit 452 inputs the i-th estimated unit environment and the (i-1)-th estimated unit environment from the fused unit environment estimation unit 451, and inputs a target phoneme/prosodic information from the unit selection unit 44. By calculating the equation (5) using these input values, the distortion estimation unit 452 calculates a synthesis unit cost of new speech unit fused by the speech unit combination candidates of i-th segment.

In this case, “uᵢ” in the equations (1)˜(5) is a new speech unit fused by the speech unit combination candidates of i-th segment, and “vᵢ” is i-th estimated unit environment.

As mentioned-above, estimated unit environment of adjacent phoneme is a combination of unit environment of adjacent phonemes of a plurality of speech units. Accordingly, in the equation (3), p(vᵢ,j) has a plurality of values as pᵢ_{_{—}}ⱼ_{_{—}}₁, . . . , Pᵢ_{_{—}}ⱼ_{_{—}}_{M} (M: number of speech units fused). On the other hand, a target phoneme environment p(tᵢ,j) has one value as Pₜ_{_{—}}ᵢ_{_{—}}ⱼ. Accordingly, d(p(vᵢ,j), p(tᵢ,j)) in the equation (3) is calculated as follows.

$$d ( p ( {v}_{i} , j ) , p ( {t}_{i} , j ) ) = \frac{1}{M} {\sum }_{m = 1}^{M} d ( {p}_{i\_j \_m} , {p}_{t\_i \_j} ) \qquad ( 7 )$$

A synthesis unit cost of speech unit combination candidates of i-th segment (calculated by the distortion estimation unit 452) is output as an estimated distortion of i-th fused speech unit from the fused unit distortion estimation unit 45.

Next, operation of the unit selection unit 44 is explained. The unit selection unit 44 divides the input phoneme sequence into a plurality of segments (each synthesis unit), and selects a plurality of speech units for each segment. The plurality of speech units for each segment are called a speech unit combination candidate.

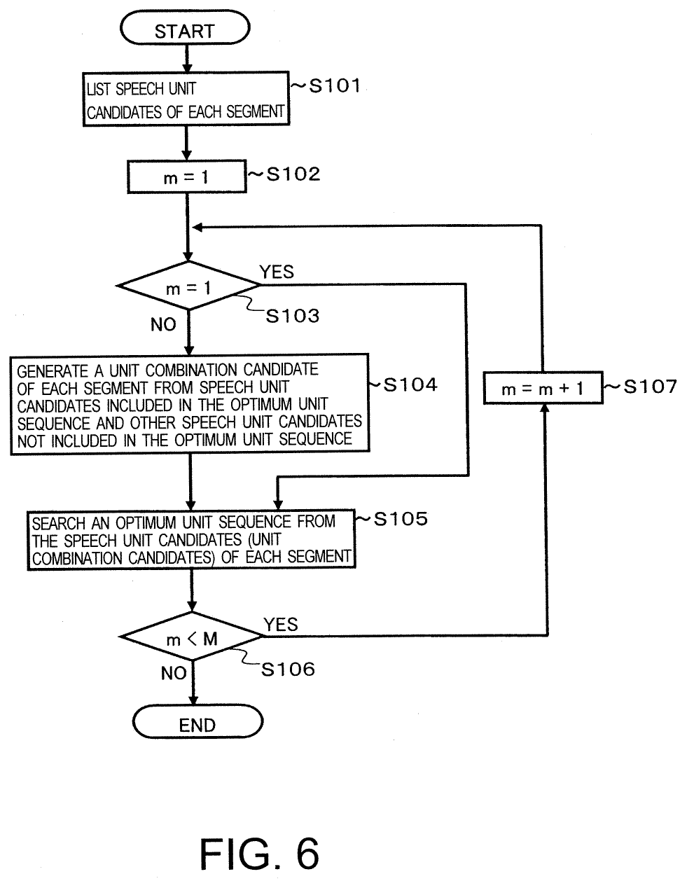

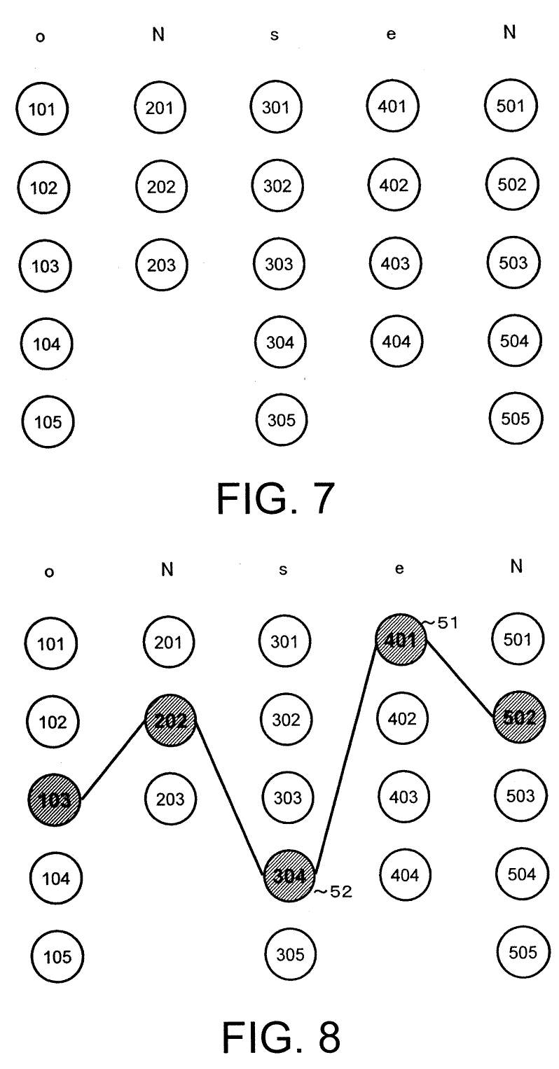

By referring to FIGS. 6-11, a method for selecting a plurality of speech units (maximum: M) of each segment is explained. FIG. 6 is a flow chart of a method for selecting speech units of each segment. FIGS. 7-11 are schematic diagrams of speech unit combination candidates selected at each step of the flow chart of FIG. 6.

First, the unit selection unit 44 extracts speech unit candidates for each segment from speech units stored in the speech unit corpus 42 (S101) FIG. 7 is an example of speech unit candidates extracted for an input phoneme sequence “o N s e N”. In FIG. 7, a white circle listed under each phoneme sign represents a speech unit candidate of each segment, and a numeral in the white circle represents each unit number.

Next, the unit selection unit 44 sets a counter m to an initial value “1” (S102), and decides whether the counter m is “1” (S103). If the counter m is not “1”, processing is forwarded to S 104 (No at S103). If the counter m is “1”, processing is forwarded to S 105 (Yes at S103).

In case of forwarding to S103 after S102, the counter m is “1”, and processing is forwarded to S105 by skipping S104. Accordingly, processing of S105 is first explained and processing of S104 is explained afterwards.

From listed speech unit candidates, the unit selection unit 44 searches for a speech unit sequence to minimize a total cost calculated by equation (6) (S105). The speech unit sequence having the minimum total cost is called an optimum unit sequence.

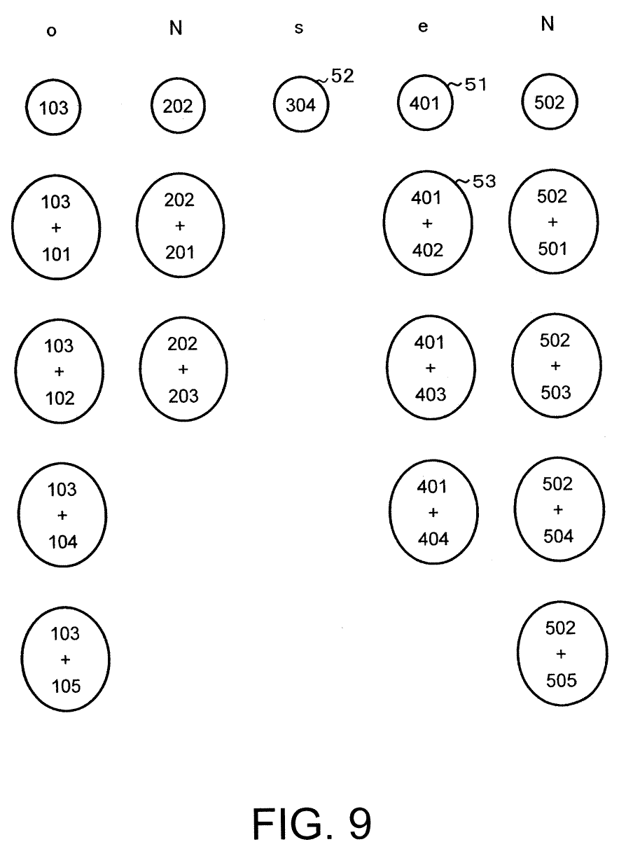

FIG. 8 is an example of the optimum unit sequence selected from speech unit candidates listed in FIG. 7. The selected speech unit candidate is represented by an oblique line. As mentioned-above, a synthesis unit cost necessary for the total cost is calculated by the fused unit distortion estimation unit 45. For example, in case of calculating a synthesis unit cost of a speech unit 51 in the optimum unit sequence of FIG. 9, the unit selection unit 44 outputs a unit number “401” of the speech unit 51, a unit number “304” of a previous speech unit 52, and a target phoneme/prosodic information to the fused unit distortion estimation unit 45. The fused unit distortion estimation unit 45 calculates a synthesis unit cost of the speech unit 51, and outputs the synthesis unit cost to the unit selection unit 44. The unit selection unit 44 calculates a total cost by summing the synthesis unit cost of each speech unit, and searches for an optimum unit sequence based on the total cost. Searching for the optimum unit sequence may be effectively executed using a Dynamic Programming Method.

Next, the counter m is compared to a maximum M of the number of speech units to be fused (S106). If the counter m is not less than M, processing is completed (No at S106). If the counter m is less than M (Yes at S106), the counter m is incremented by “1” (S107), and processing is returned to S103.

At S103, the counter m is compared to “1”. In this case, the counter m is already incremented by “1” at S107. As a result, the counter m is above “1”, and processing is forwarded to S104 (No at S103).

At S 104, based on speech units included in the optimum unit sequence (previously searched at S105) and other speech units not included in the optimum unit sequence, a speech unit combination candidate of speech units of each segment is generated. Each speech unit included in the optimum unit sequence is combined with another speech unit (not included in the optimum unit sequence) in speech unit candidates listed for each segment. The combined speech units of each segment are generated as unit combination candidates.

FIG. 9 shows example unit combination candidates. In FIG. 9, each speech unit in the optimum unit sequence selected in FIG. 8 is combined with another speech unit in the speech unit candidates (not in the optimum unit sequence) of each segment, and generated as a unit combination candidate. For example, a unit combination candidate 53 in FIG. 9 is a combination of a speech unit 51 (unit number 401) in the optimum unit sequence and another speech unit (unit number 402).

In the first embodiment, fusion of speech units by the unit fusion unit 46 is executed for voiced sound and not executed for unvoiced sound. As to a segment of unvoiced sound “s”, each speech unit in the optimum unit sequence is not combined with another speech unit not in the optimum unit sequence. In this case, a speech unit 52 (unit number 304) of unvoiced sound in the optimum unit sequence first obtained at S105 in FIG. 6 is regarded as a unit combination candidate.

Next, at S105, a sequence of optimum unit combination (Hereinafter, it is called an optimum unit combination sequence) is searched from unit combination candidates of each segment. As mentioned-above, a synthesis unit cost of each unit combination candidate is calculated by the fused unit distortion estimation unit 45. Searching for the optimum unit combination sequence is executed using a Dynamic Programming Method.

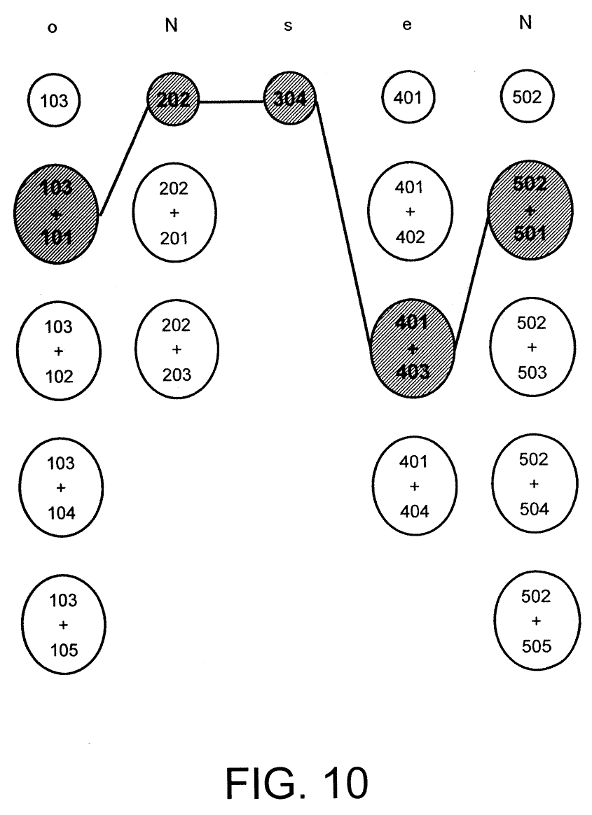

FIG. 10 shows example optimum unit combination sequences selected from unit combination candidates in FIG. 9. Selected speech units are represented by an oblique line. Hereinafter, processing steps S103-S107 are repeated until the counter m is above the maximum M of the number of speech units to be fused.

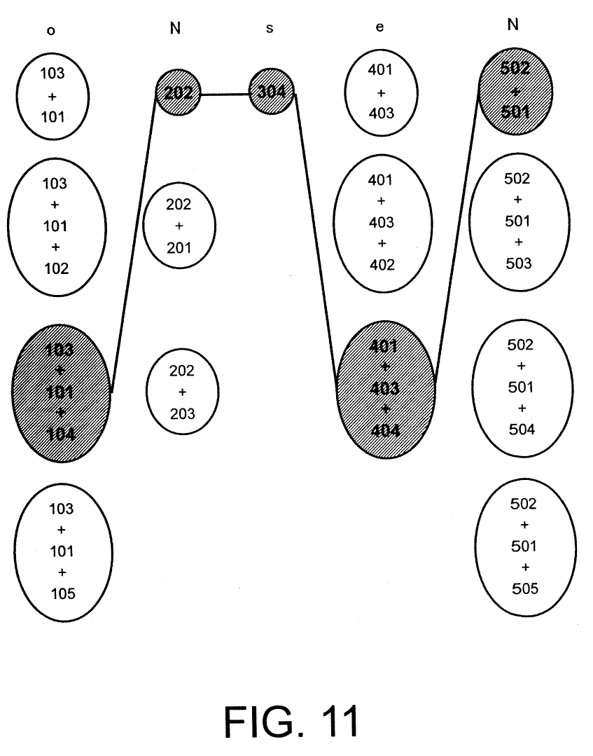

FIG. 11 is an example of the optimum unit combination sequence selected in case of “M=3”. In this example, as to a phoneme “o” of the first segment, three speech units of unit numbers “103, 101, 104” in FIG. 8 are selected. As to a phoneme “N” of the second segment, one speech unit of unit number “202” is selected.

A method for selecting a plurality of speech units for each segment by the unit selection unit 44 is not limited to above-mentioned method. For example, all combinations including speech units of maximum M are first listed. By searching for an optimum unit combination sequence from all combinations listed, a plurality of speech units may be selected for each segment. In this method, in case of a large number of speech unit candidates, a number of speech unit combinations listed of each segment is very large, and great calculation cost and memory size are necessary. However, this method is effective to select the optimum unit combination sequence. Accordingly, if a high calculation cost and a large memory are permitted, selection result of this method is better than above-mentioned method.

The unit fusion unit 46 generates new speech unit of each segment by fusing the unit combination candidates selected by the unit selection unit 44. In the first embodiment, as to a segment of voiced sound, speech units are fused because effect to fuse speech units is notable. As to a segment of unvoiced sound, one speech unit selected is used without fusion.

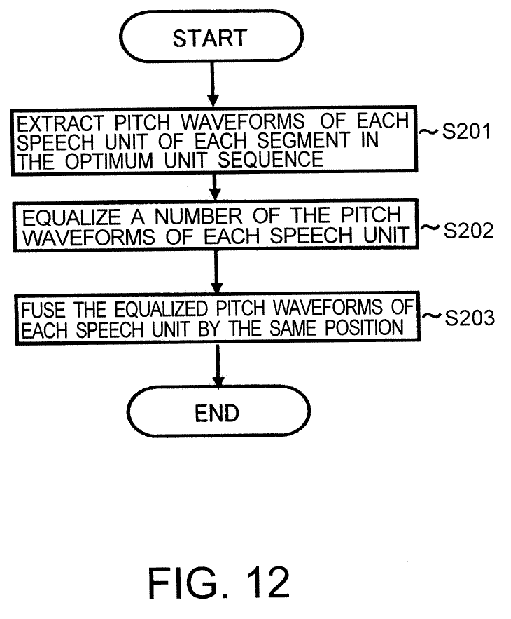

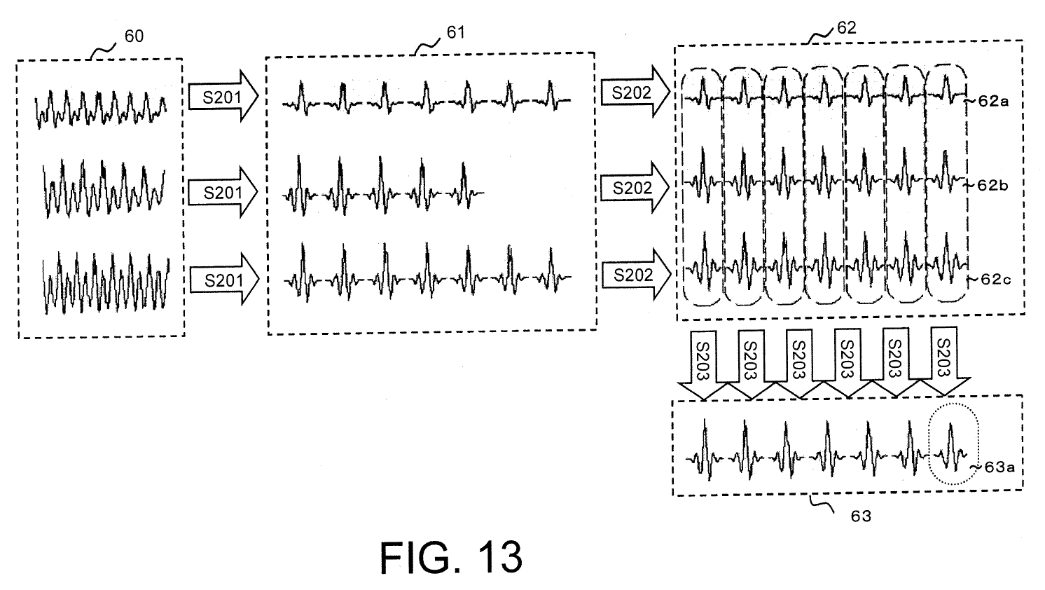

A method for fusing speech units of voiced sound is disclosed in JP-A (Kokai) No. 2005-164749. In this case, the method is explained by referring to FIGS. 12 and 13. FIG. 12 is a flow chart of generation of new speech waveform fused from speech waveforms of voiced sound. FIG. 13 is an example of generation of new speech unit 63 fused from unit combination candidates 60 of three speech units selected for some segment.

First, a pitch waveform of each speech unit of each segment in the optimum unit sequence is extracted from the speech unit corpus 42 (S201). The pitch waveform is a relative short waveform having a period several times the fundamental frequency of speech, and does not have a fundamental frequency. A spectral represents a spectral envelop of a speech signal. As one method for extracting such pitch waveform, a method using a synchronous window of fundamental frequency is applied. A mark (pitch mark) is attached to a fundamental frequency interval of speech waveform of each speech unit. By setting the Hanning window having a length twice the fundamental period centering around the pitch mark, a pitch waveform is extracted. Pitch waveforms 61 in FIG. 13 represent an example of pitch waveform sequence extracted from each speech unit of unit combination candidate 60.

Next, a number of pitch waveforms of each speech unit are equalized among all speech units of the same segment (S202). In this case, the number of pitch waveforms to be equalized is a number of pitch waveforms necessary to generate a synthesized speech of target segmental duration. For example, the number of pitch waveforms of each speech unit may be equalized as the largest number of one pitch waveform in the pitch waveforms. As to a pitch waveform sequence having a small number of pitch waveforms, the number of pitch waveforms increases by copying some pitch waveform in the sequence. As to a pitch waveform sequence having a large number of pitch waveforms, the number of pitch waveforms decreases by sampling some pitch waveform from the sequence. In a pitch waveform sequence 62 in FIG. 13, the number of pitch waveforms is equalized as seven.

After equalizing the number of pitch waveforms, by fusing pitch waveforms of each speech unit at the same position, a new pitch waveform sequence is generated (S203). In FIG. 13, a pitch waveform 63a in new pitch waveform sequence 63 is generated by fusing the seventh pitch waveform 62a, 62b, and 62c in each pitch waveform sequence 62. Such new pitch waveform sequence 63 is a fused speech unit.

Several methods for fusing pitch waveforms can be selectively used. As a first method, an average of pitch waveforms is simply calculated. As a second method, after correcting a position of each pitch waveform along a time direction to maximize correlation between pitch waveforms, the average of pitch waveforms is calculated. As a third method, a pitch waveform is divided into each band, a position of pitch waveform is corrected to maximize correlation between pitch waveforms of each band, the pitch waveforms of the same band are averaged, and the averaged pitch waveforms of each band are summed. In the first embodiment, the third method is used.

As to a plurality of segments corresponding to an input phoneme sequence, the unit fusion unit 46 fuses a plurality of speech units included in a unit combination candidate of each segment. In this way, a new speech unit (Hereinafter, it is called a fused speech unit) is generated for each segment, and output to the unit editing/concatenation unit 47.

The unit editing/concatenation unit 47 modifies (edits) and concatenates a fused speech unit of each segment (input from the unit fusion unit 46) based on input prosodic information, and generates a speech waveform of a synthesized speech. The fused speech unit (generated by the unit fusion unit 46) of each segment is actually a pitch waveform. Accordingly, by overlapping and adding pitch waveforms so that a fundamental frequency and a phoneme segmental duration of the fused speech unit are respectively equal to a fundamental frequency and a phoneme segmental duration of target speech in input prosodic information, a speech waveform is generated.

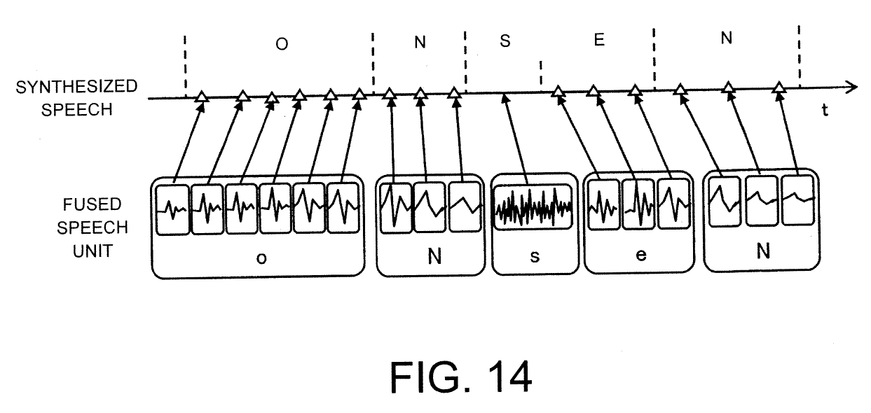

FIG. 14 is a schematic diagram to explain processing of the unit editing/concatenation unit 47. In FIG. 14, a fused speech unit of each synthesis unit of phonemes “o” “N” “s” “e” “N” (generated by the unit fusion unit 46) is modified and concatenated. As a result, a speech unit “ONSEN” is generated. In FIG. 14, a dotted line represents a segment boundary of each phoneme divided based on target phoneme segmental duration. A white triangle represents a position (pitch mark) to overlap and add each pitch waveform located based on target fundamental frequency. As shown in FIG. 14, as to voiced sound, each pitch waveform of the fused speech unit is overlapped and added to a corresponding pitch mark. As to unvoiced speech, a speech unit waveform is prolonged to equal to length of a segment, and overlapped and added on the segment.

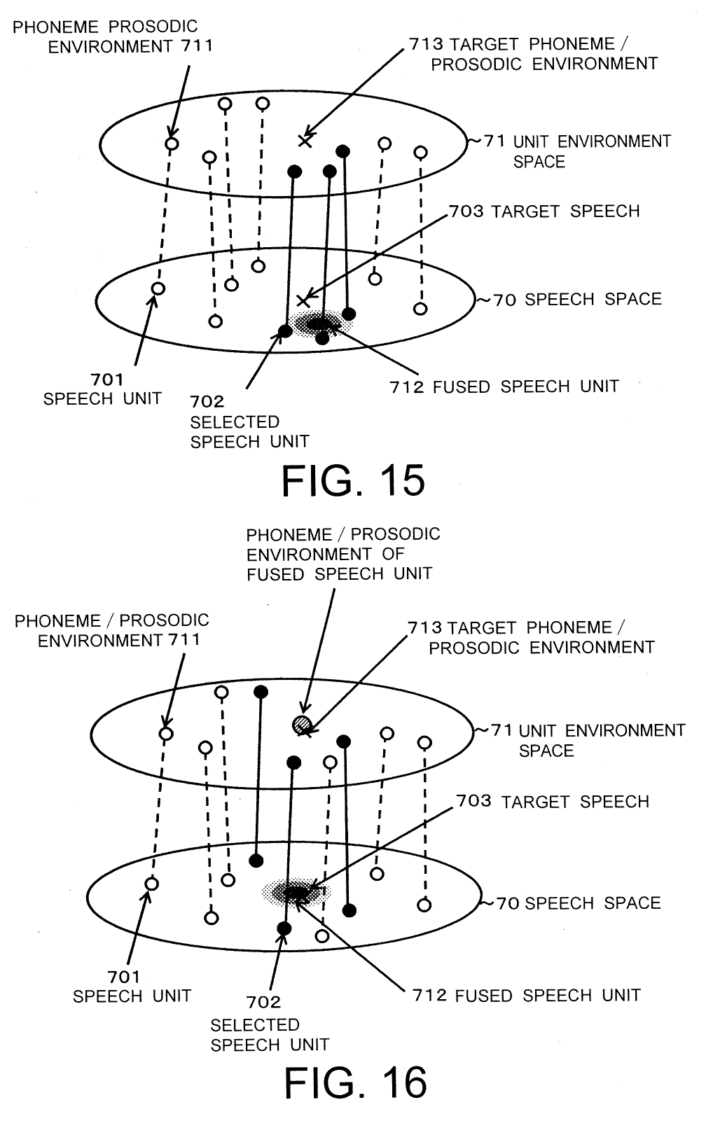

As mentioned-above, in the first embodiment, the fused speech unit distortion estimation unit 45 estimates a distortion caused by fusing unit combination candidates of each segment. Based on the estimation result, the unit selection unit 44 generates a new unit combination candidate for each segment. As a result, speech units having high fusion effect can be selected in case of fusing the speech units. This concept is explained by referring to FIGS. 15 and 16.

FIG. 15 is a schematic diagram of unit selection in case of not estimating a distortion of fused speech unit. In FIG. 15, in case of selecting speech units, a speech unit having phoneme/prosodic environment closely related to the target speech is selected. A plurality of speech units 701 distributed in a speech space 70 are shown by a white circle. A phoneme/prosodic environment 711 of each speech unit 701 distributed in a unit environment space 71 is represented as a black circle. Furthermore, the correspondence between each speech unit 701 and a phoneme/prosodic environment 711 is represented by a broken line and a solid line. The black circle represents a speech unit 702 selected by the unit selection unit 44. By fusing speech units 702, a new speech unit 712 is generated. Furthermore, a target speech 703 exists in the speech space 70, and a target phoneme/prosodic environment 713 of the target speech 703 exists in the unit environment space 71.

In this case, distortion of fused speech units is not estimated, and a speech unit 702 having phoneme/prosodic environment closely related to the target phoneme/prosodic environment 713 is simply selected. As a result, the new speech unit 712 generated by fusing the selected speech units 702 is shifted from the target speech 703. In the same way as the case of using one selected speech unit without fusion, speech quality falls.

On the other hand, FIG. 16 is a schematic diagram of unit selection when estimating a distortion of fused speech units. Except for selected speech unit represented by black circle, the same signs are used in FIGS. 15 and 16.

In FIG. 16, the unit selection unit 44 selects a speech unit to minimize an estimated distortion of fused speech unit (estimated by the distortion estimation unit 452). In other words, the speech unit 702 is selected so that estimated unit environment of fused speech unit (fused by selected speech units) is equal to phoneme/prosodic environment of target speech. As a result, speech units 702 of black circles are selected by the unit selection unit 44, and new speech unit 712 generated from the speech units 702 closely relates to the target speech 703.

In this way, based on distortion of fused speech unit (estimated by the fused speech unit distortion estimation unit 45), the unit selection unit 44 selects a unit combination candidates of each segment. Accordingly, in case of fusing the unit combination candidates, the speech units having high fusion effect can be obtained.

Furthermore, in case of selecting the unit combination candidates of each segment, the fused speech unit distortion estimation unit 45 estimates a distortion of fused speech unit by increasing a number of speech units to be fused without fixing the number of speech units. Based on the estimation result, the unit selection unit 44 selects the unit combination candidates. Accordingly, the number of speech units to be fused can be suitably controlled for each segment.

Furthermore, in the first embodiment, the unit selection unit 44 selects an adaptive number of speech units having a high fusion effect in case of fusing the speech units. Accordingly, a natural synthesis speech having high quality can be generated.

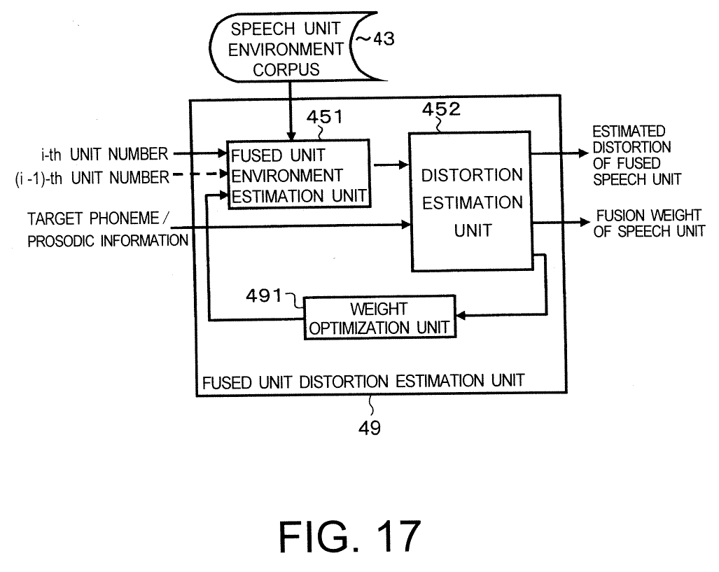

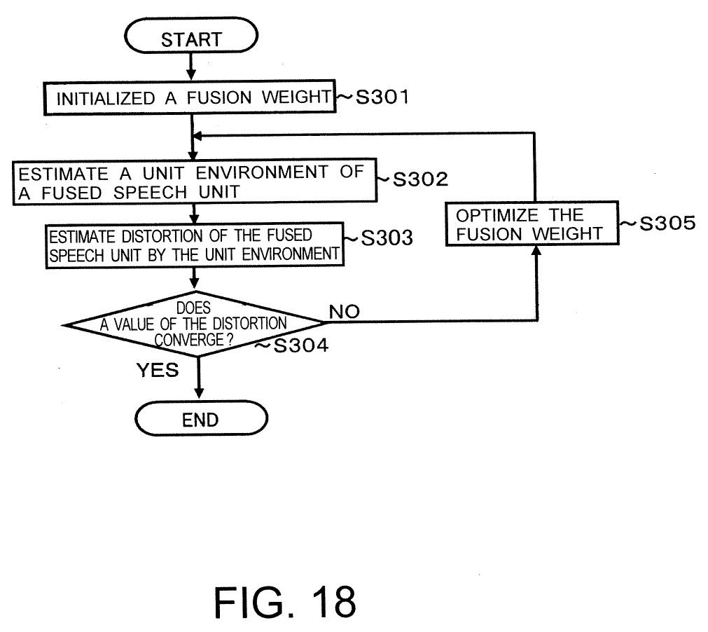

Next, the speech synthesis apparatus of the second embodiment is explained by referring to FIGS. 17 and 18. FIG. 17 is a block diagram of the fused unit distortion estimation unit 49 of the second embodiment. In comparison with the fused unit distortion estimation unit 45 of FIG. 5, the fused unit distortion estimation unit 49 includes a weight optimization unit 491. In case of inputting unit numbers of speech units of i-th segment and (i-1)-th segment, and target phoneme/prosodic environment from the unit selection unit 44, in addition to the estimated distortion of fused speech unit, the weight optimization unit 491 outputs a weight of each speech unit (Hereinafter, it is called a fusion weight) to be fused. Other operations are the same as the speech synthesis unit 4. Accordingly, the same reference numbers are assigned to the same units.

Next, operation of the fused unit distortion estimation unit 49 is explained by referring to FIG. 18. FIG. 18 is a flow chart of processing of the fused unit distortion estimation unit 49. First, in case of inputting unit numbers of speech units of the i-th segment and the (i-1)-th segment, and target phoneme/prosodic environment from the unit selection unit 44, the weight optimization unit 491 initializes a fusion weight of each speech unit of the i-th segment by 1/L (S301). This initialized fusion weight is input to the fused unit environment estimation unit 451. “L” is a number of speech units of the i-th segment.

The fused unit environment estimation unit 451 inputs the fusion weight from the weight optimization unit 491, and unit numbers of speech units of the i-th segment and the (i-1)-th segment from the unit selection unit 44. The fused unit environment unit 451 calculates an estimated unit environment of i-th fused speech unit based on the fusion weight of each speech unit of the i-th segment (S302). As to unit environment factor (For example, fundamental frequency, phoneme segmental duration, cepstrum coefficient) having continuous quantity, instead of calculating the average of each factor, the estimated unit environment of fused speech unit is obtained as an average of the sum of each factor with fusion weight. For example, a phoneme segmental duration g(vᵢ) of fused speech unit in equation (2) is represented as follows.

$$g ( {v}_{i} ) = {\sum }_{m = 1}^{M} {w}_{i\_m} \cdot g ( {v}_{i\_m} ) \qquad ( 8 )$$

wᵢ_{_{—}}ₘ: fusion weight of m-th speech unit of i-th segment

(wᵢ_{_{—}}₁+ . . . . +wᵢ_{_{—}}_{M}=1)

vᵢm: unit environment of m-th speech unit of i-th segment

On the other hand, as to adjacent phoneme as discrete symbol, in the same way as the first embodiment, combination of adjacent phonemes of a plurality of speech units is regarded as adjacent phonemes of new speech unit fused from the plurality of speech units.

Next, based on the estimated unit environment of i-th fused speech unit (and the estimated unit environment of (i-1)-th fused speech unit) from the fused unit environment estimation unit 451, the distortion estimation unit 452 estimates a distortion between a target speech and a synthesized speech using i-th fused speech unit (S303). Briefly, a synthesis unit cost of the fused speech unit (generated by summing each speech unit with the fusion weight) of i-th segment is calculated by the equation (5). In case of calculating “d(p(vᵢ,j),p(tᵢ,j))” by the equation (3) to calculate a phoneme environment cost, inter-phoneme distance reflecting the fusion weight is calculated by the following equation instead of the equation (7).

$$d ( p ( {v}_{i} , j ) , p ( {t}_{i} , j ) ) = {\sum }_{m = 1}^{M} {w}_{i\_m} \cdot d ( {p}_{i\_j \_m} , {p}_{t\_i \_j} ) \qquad ( 9 )$$

The distortion estimation unit 452 decides whether a value of estimated distortion of the fused speech unit converges (S304). In case that the estimated distortion of fused speech unit calculated by present loop in FIG. 18 is Cⱼ and the estimated distortion of fused speech unit calculated by previous loop in FIG. 18 is Cⱼ₋₁, convergence of the value of the estimated distortion occurs if “|Cⱼ-Cⱼ₋₁|≦ε(ε: constant near “0”)”. In case of convergence, the value of estimated distortion of fused speech unit and the fusion weight used for calculation are output to the unit selection unit 44 (Yes at S304).

On the other hand, in case of non-convergence of the value of estimated distortion of fused speech (No at S304), the weight optimization unit 491 optimizes a fusion weight “(wᵢ_{_{—}}₁, . . . , wᵢ_{_{—}}_{M})”on condition that “wᵢ_{_{—}}₁+ . . . +wᵢ_{_{—}}_{M}≧0” to minimize the estimated distortion of fused speech unit (synthesis unit cost C(uᵢ,uᵢ₋₁,tᵢ) calculated by the equation (5)) (S305).

In order to optimize the fusion weight, first, the following equation is assigned to “C(uᵢ, u₁₋₁, tᵢ)”.

$${w}_{i\_M} = 1 - {\sum }_{m = 1}^{M - 1} {w}_{i\_m} \qquad ( 10 )$$

Second, “C(uᵢ, uᵢ₋₁, tᵢ)” is partially differentiated by “wᵢ_{_{—}}ₘ(m=1, . . . , M-1)”.

Third, this partial differential equation is set as “0” as follows.

$$\frac{\partial }{\partial {w}_{i\_m}} C ( {u}_{i} , {u}_{i - 1} , {t}_{i} ) = 0 ( m = 1 , … , M - 1 ) \qquad ( 11 )$$

Briefly, the simultaneous equation (11) is solved.

If the equation (11) is not analytically solved, by searching for a fusion weight to minimize the equation (5) using known optimization method, the fusion weight is optimized. After optimizing the fusion weight by the weight optimization unit 491, the fused unit environment estimation unit 451 calculates an estimated unit environment of fused speech unit (S302).

The estimated distortion and the fusion weight of fused speech unit (calculated by the fused unit distortion estimation unit 49) are input to the unit selection unit 44. Based on the estimated distortion of fused speech unit, the unit selection unit 44 generates a unit combination candidate of each segment to minimize a total cost of the unit combination candidates of all segments. The method for generating the unit combination candidate is the same as shown in the flow chart of FIG. 6.

Next, the unit combination candidate (generated by the unit selection unit 44) and the fusion weight of each speech unit included in the unit combination candidate are input to the unit fusion unit 46. The unit fusion unit 46 fuses each speech unit using the fusion weight for each segment. A method for fusing speech units included in the unit combination candidate is almost the same as shown in the flow chart of FIG. 12. A different point is that, at fusion processing of pitch waveforms by the same position (S203 in FIG. 12), in case of averaging the pitch waveforms by each band, the pitch waveforms are averaged by multiplying the fusion weight with corresponding pitch waveform. Other processing and operation after fusing each speech unit are same as the first embodiment.

As mentioned-above, in the second embodiment, in addition to effect of the first embodiment, the weight optimization unit 491 calculates a fusion weight to minimize distortion of fused speech unit, and the fusion weight is used for fusing each speech unit included in the unit combination candidate. Accordingly, a fused speech unit closely related to a target speech is generated for each segment, and a synthesized speech having higher quality can be generated.

In the disclosed embodiments, the processing can be accomplished by a computer-executable program, and this program can be realized in a computer-readable memory device.

In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. An apparatus for synthesizing speech, comprising:
a speech unit corpus configured to store a group of speech units;
a selection unit configured to divide a phoneme sequence of target speech into a plurality of segments, and to select a combination of speech units for each segment from the speech unit corpus;
an estimation unit configured to estimate a distortion between the target speech and synthesized speech generated by fusing each speech unit of the combination for each segment;
wherein the selection unit recursively selects the combination of speech units for each segment based on the distortion,
a fusion unit configured to generate a new speech unit for each segment by fusing each speech unit of the combination selected for each segment; and
a concatenation unit configured to generate synthesized speech by concatenating the new speech unit for each segment.

2. The apparatus according to claim 1,
further comprising a speech unit environment corpus configured to store environment information corresponding to each speech unit of the group stored in the speech unit corpus.

3. The apparatus according to claim 2,
wherein the environment information includes a unit number, a phoneme, adjacent phonemes in front and rear of the phoneme, a fundamental frequency, a phoneme segmental duration, and a cepstrum coefficient of a start point and an end point of a speech waveform.

4. The apparatus according to claim 3,
wherein the speech unit corpus stores the speech waveform corresponding to the unit number.

5. The apparatus according to claim 1,
further comprising a phoneme sequence/prosodic information input unit configured to input the phoneme sequence and a prosodic information of the target speech.

6. The apparatus according to claim 1,
wherein the selection unit recursively changes the number of speech units of the combination for each segment based on the distortion.

7. The apparatus according to claim 2,
wherein the estimation unit extracts the environment information of each speech unit of the combination from the speech unit environment corpus, estimates a phoneme/prosodic environment of the new speech unit based on the environment information extracted, and estimates the distortion based on the phoneme/prosodic environment.

8. The apparatus according to claim 1,
wherein the selection unit selects a plurality of combinations of speech units for each segment, and
wherein the estimation unit respectively estimates the distortion for each of the plurality of combinations.

9. The apparatus according to claim 8,
wherein the selection unit selects one combination of speech units for each segment from the plurality of combinations, the one combination having the minimum distortion among all distortions of the plurality of combinations.

10. The apparatus according to claim 9,
wherein the selection unit differently adds at least one speech unit not included in the one combination to the one combination, and selects a plurality of new combinations of speech units for each segment, each of the plurality of new combinations being differently an addition result of the at least one speech unit and the one combination.

11. The apparatus according to claim 10,
wherein the estimation unit respectively estimates the distortion for each of the plurality of new combinations, and
wherein the selection unit selects one new combination of speech units for each segment from the plurality of new combinations, the one new combination having the minimum distortion among all distortions of the plurality of new combinations.

12. The method according to claim 11,
wherein the selection unit recursively selects a plurality of new combinations of speech units for each segment plural times.

13. The method according to claim 4,
wherein the fusion unit extracts the speech waveform of each speech unit of the combination of the same segment from the speech unit corpus, equalizes the number of speech waveforms of each speech unit, and fuses the speech waveform equalized of each speech unit.

14. The method according to claim 1,
wherein the estimation unit optimally determines a weight between two speech units to minimize the distortion by fusing each speech unit of the combination, and
wherein the fusion unit fuses each speech unit of the combination based on the weight.

15. The method according to claim 14,
wherein the estimation unit repeatedly determines the weight until the distortion converges as the minimum.

16. The method according to claim 1,
wherein the estimation unit estimates the distortion based on a first cost and a second cost,
wherein the first cost represents a distortion between the target speech and a synthesized speech generated using the new speech unit of each segment, and
wherein the second cost represents a distortion caused by concatenation between the new speech unit of the segment and another new speech unit of another segment adjacent to the segment.

17. The method according to claim 16,
wherein the first cost is calculated using at least one of a fundamental frequency, a phoneme segmental duration, a power, a phoneme environment, and a spectral.

18. The method according to claim 16,
wherein the second cost is calculated using at least one of a spectral, a fundamental frequency, and a power.

19. A method for synthesizing speech, comprising:
storing a group of speech units;
dividing a phoneme sequence of target speech into a plurality of segments;
selecting a combination of speech units for each segment from the group of speech units;
estimating a distortion between the target speech and synthesized speech generated by fusing each speech unit of the combination for each segment;
recursively selecting the combination of speech units for each segment based on the distortion;
generating a new speech unit for each segment by fusing each speech unit of the combination selected for each segment; and
generating synthesized speech by concatenating the new speech unit for each segment.

20. A computer program product, comprising:
a computer readable program code embodied in said product for causing a computer to synthesize speech, said computer readable program code comprising:
a first program code to store a group of speech units;
a second program code to divide a phoneme sequence of target speech into a plurality of segments;
a third program code to select a combination of speech units for each segment from the group of speech units;
a fourth program code to estimate a distortion between the target speech and synthesized speech generated by fusing each speech unit of the combination for each segment;
a fifth program code to recursively select the combination of speech units for each segment based on the distortion;
a sixth program code to generate a new speech unit for each segment by fusing each speech unit of the combination selected for each segment; and
a seventh program code to generate synthesized speech by concatenating the new speech unit for each segment.
